(19) United States
(12) Patent Application Publication
(10) Pub. No.: US 2025/0017226 A1
(43) Pub. Date: Jan. 16, 2025

(54) PROSOPIS JULIFLORA WATER-SOLUBLE LEAF ETHANOLIC (PJ-WS-LE) EXTRACT AS A PREVENTIVE COATING FOR POST-HARVEST FRUITS

(71) Applicant: QATAR UNIVERSITY, Doha (QA)

(72) Inventors: Mohammed ABU-DIEYEH, Doha (QA); Imane SALEH, Doha (QA)

(21) Appl. No.: 18/772,403

(22) Filed: Jul. 15, 2024

Related U.S. Application Data
(60) Provisional application No. 63/526,822, filed on Jul. 14, 2023.

(51) Int. Cl. A23B 7/154; A23B 7/16; B01D 11/02

(52) U.S. Cl. CPC A23B 7/154; A23B 7/16; B01D 11/0257

(57) ABSTRACT

The present disclosure provides compositions and methods of preparing a Prosopis juliflora water-soluble leaf ethanolic extract, wherein the Prosopis juliflora water-soluble leaf ethanolic extract can be applied as an antimicrobial and antifungal agent for post-harvest vegetation.

### CROSS REFERENCE TO RELATED APPLICATION

This application claims priority to, and the benefit of, U.S. Provisional Patent Application No. 63/526,822 filed Jul. 14, 2023. The entirety of the application is incorporated herein by reference for all purposes.

### BACKGROUND

Food security is one of the major worldwide challenges and a pillar in Qatar National Vision 2030. The agricultural industry is a booming sector in Qatar. Yet a high percentage of the fruits consumed in Qatar are imported. Postharvest microbial infections of fruits and vegetables are mainly caused by fungal and bacterial pathogens that can be harmful to both human and animals. Such pathogens also lead to high economic losses to both manufacturers and consumers.

Chemical antibiotics and fungicides have an environmental pollution footprint and are therefore not the recommended option to extend fresh produce shelf life. In fact, many countries around the world are setting a maximum residue limits (MRL) of chemicals on the skin of their fruits and vegetables. Further, when pesticides are applied, only about 0.1% of the applied amount reaches the target pests, while the remaining 99.9% often drift to affect non-target population and/or remain in the environment, causing losses in the biodiversity and elimination of key species, water pollution, and soil contamination. Therefore, pesticides reach humans directly on the fresh of produce and indirectly through the environment to cause a variety of health problems. In addition, spoiling microorganisms are gaining resistance to the commonly used antimicrobial agents. What are needed are natural novel products to replace synthetic chemical applications in the field and at post-harvest stage.

A successful product should control pre-existing infections and leave residues that prevent subsequent infections and retard sporulation of the existing spores to reduce economical losses. In the case of fungi, applying an affordable natural non-hazardous formulation would prevent visible spoilage and would inhibit the growth of the fungi early before the formation of mycotoxins that are a burden on human health even after the decontamination of food products from the main contaminants.

What are needed are solutions to solve this worldwide problem, especially in Qatar. Although agricultural projects are evolving in Qatar, the climate conditions and the arid land nature of the country impose limitations on plant productivity. Local agriculture, even if it covers a part of the local consumption, is costly. Many imported fruits are spoiled in stores, and many of the locally produced vegetables have short shelf life.

### SUMMARY

Prosopis juliflora is an invasive species in the state of Qatar. Chemical and mechanical invasion control is expensive and not recommended because of their possible adverse effects on the environment. Using the leaves of this plant to prepare an extract that can serve as bio-controller or natural anti-spoiling agents would both provide a use of the unwanted plant and solve a major food security problem.

Plant extract prepared from the leaves of Prosopis juliflora were explored as a natural antimicrobial agent against different Penicillium strains and as a coating material to extend citrus fruit shelf-life and to maintain their storage parameters. Prosopis juliflora extract has been studied for its anti-microbial activity, anti-inflammatory effectiveness, and other benefits. The ethanolic extract of the leaves exhibited an anti-microbial effect. It was also able to extend the shelf-life of various fruits and vegetables including strawberry, mango, and cucumber.

Prosopis juliflora water-soluble leaf ethanolic (PJ-WS-LE) extract is an affordable plant-based formulation that helps in fighting root rot in the field and in preventing post-harvest spoilage. It would support the agricultural domain not only globally but also in the countries that are most in need of support. It is water soluble, stable with time, and heat stable up to 70° C., which means that it can be easily applied in the form of a spray or embedded in any stabilizing packaging. It is also suitable for hot weather. The extraction method is simple and not costly. The tree is an invasive species that is available in many countries in the world and can be cultivated easily in places where it doesn't naturally grow.

The present disclosure provides a method of preparing a Prosopis juliflora water-soluble leaf ethanolic extract, wherein the method includes providing Prosopis juliflora leaf powder; combining the Prosopis juliflora leaf powder and a first solvent comprising a first ethanol solution in a first shaker-incubator for at least 48 hours to obtain a first shaken solution; isolating a first supernatant from the first shaken solution; obtaining a first dried material from a centrifugation of the first supernatant by evaporating the first solvent; combining additional Prosopis juliflora leaf powder and a second solvent comprising a second ethanol solution in a second shaker-incubator for at least 24 hours to obtain a second shaken solution; isolating a second supernatant from the second shaken solution; and obtaining a second dried material from a centrifugation of the second supernatant and second solvent evaporation; adding the dried material from both elution to distilled water to prepare a stock solution; and centrifuging the stock solution and getting rid of the non-water soluble material to end up with the final stock solution to form the Prosopis juliflora water-soluble leaf ethanolic extract.

In an embodiment, the disclosure provides a composition comprising the Prosopis juliflora water-soluble leaf ethanolic extract.

In an embodiment, the disclosure provides a method of protecting post-harvest vegetation, wherein the method includes applying the composition to the outer surface of post-harvest vegetation.

### BRIEF DESCRIPTION OF THE DRAWINGS

FIG. 1: Flow diagram of the PJ-WS-LE extract procedure.

FIG. 2: Pour plate method results of Penicillium purpurogenum strain.

FIG. 3A: 96-well plate results for Penicillium Strain 1 (Penicillium purpurogenum).

FIG. 3B: 96-well plate results for Penicillium Strain 2 (Penicillium digitatum).

FIG. 3C: 96-well plate results for Penicillium Strain 3 (Penicillium italicum).

FIG. 3D: 96-well plate results for Penicillium Strain 4 (Penicillium digitatum).

FIG. 3E: 96-well plate results for Penicillium Strain 5 (Penicillium italicum).

FIG. 3F: 96-well plate results for Penicillium Strain 6 (Penicillium digitatum).

FIG. 4A-4I: Preventive and curative effect of PJ-WS-LE extract on Penicillium digitatum and Penicillium italicum artificially inoculated into lemon and orange samples.

FIG. 5: Curative and preventive measured parameters (disease incidence (DI) and percent plant extract efficacy (% EE)) of PJ-WS-LE extract against Penicillium italicum and Penicillium digitatum inoculated in lemon samples.

FIG. 6: Curative and preventive measured parameters (disease incidence (DI) and percent plant extract efficacy (% EE)) of PJ-WS-LE extract against Penicillium italicum and Penicillium digitatum inoculated in orange samples. Disease incidence (DI), and percent plant extract efficacy (% EE).

Illustrative embodiments of the present invention are described in detail below with reference to the figures, which are incorporated by reference herein.

### DETAILED DESCRIPTION

The present disclosure provides compositions and methods of preparing a Prosopis juliflora water-soluble leaf ethanolic extract. The method can start with the preparation of Prosopis juliflora leaf powder, wherein Prosopis juliflora leaves are dried at a temperature between 40° C. to 50° C., and grinding the dried Prosopis juliflora leaves into the Prosopis juliflora leaf powder.

The method includes combining the Prosopis juliflora leaf powder and a first solvent comprising a first ethanol solution in a first shaker-incubator for at least 24 hours or at least 48 hours to obtain a first shaken solution. In an example, the first solvent is the first ethanol solution. The ethanol solution can be any suitable ethanol solution including 70% ethanol or 90% ethanol. In an example, the ethanol solution is 70% ethanol. The first shaker-incubator can be at a temperature of about 40° C. to 50° C., and shaking about 50 cycles/min for at least 48 hours. In an example, the temperature is 45° C.

The method includes isolating a first supernatant from the first shaken solution. The first supernatant can be obtained by filtering any precipitate from the first shaken solution.

The method includes subjecting the first supernatant to centrifugation to remove any insoluble precipitate. Alternatively, or in addition to, the first supernatant can be filtered using Whatman filter papers and the first solvent can be evaporated. The first supernatant can be poured into 150 mm glass Petri-plate and dried. The precipitate can be aseptically scratched from the surface of the petri-plates to isolate the first dried material.

Additional Prosopis juliflora leaf powder can be added to a second solvent comprising a second ethanol solution in a second shaker-incubator for at least 24 hours or at least 48 hours to obtain a second shaken solution. In an example, the second solvent is the second ethanol solution. The second ethanol solution can be placed in a second shaker-incubator is at a temperature of about 40° C. to 50° C., and shaking about 50 cycles/min for at least 48 hours. In an example, the temperature is 45° C.

A second supernatant can be isolated from the second shaken solution. For example, the second shaken solution can be filtered or centrifuged to remove any precipitate. The second supernatant can be subject to centrifugation and the evaporation of the second solvent. The second supernatant can be poured into 150 mm glass Petri-plate and dried. The precipitate can be aseptically scratched from the surface of the petri-plates to isolate the second dried material.

The method can include adding the first dried material and the second dried material (i.e., crude Prosopis juliflora water-soluble leaf ethanolic extract) to distilled water to prepare a stock solution. The stock solution can have a concentration of 100 mg/mL to 200 mg/mL. The stock solution can be centrifuged and the pellet discarded. In an example, only the water soluble material makes the stock solution of Prosopis juliflora water-soluble leaf ethanolic extract. The stock solution can be stored at 3° C. to 6° C., while the non-water-soluble pellet is incubated at about 45° C. to dry. The pellet can be weighed and the new concentration of the solution can be re-calculated. The suspension can be sterilized using a syringe filter 0.2 μm to prepare the end-product.

In an example, the first dried material can be added directly into the distilled water as the crude Prosopis juliflora water-soluble leaf ethanolic extract to prepare the stock solution without undergoing the second shaker-incubator to form the second dried material.

In an embodiment, the method includes preparing an Prosopis juliflora water-soluble leaf ethanolic extract by mixing leaf powder with 70% ethanol in a first shaker-incubator for at least 48 hours at 45° C., 50 rpm, and obtaining dried material via centrifugation of supernatant and evaporation of the solvent. The same leaf powder is combined with 70% ethanol in a bottle and incubating in a second shaker-incubator for at least 24 hours at 45° C., 50 rpm to obtain the Prosopis juliflora water-soluble leaf ethanolic extract by sterilizing water-soluble supernatant with a syringe filter.

In an embodiment, the disclosure provides a method of protecting post-harvest vegetation, wherein the method includes applying the Prosopis juliflora water-soluble leaf ethanolic extract to the outer surface of post-harvest vegetation. For example, the Prosopis juliflora water-soluble leaf ethanolic extract can be used as a preventive coating for post-harvest fruits and vegetables, wherein the coating is antimicrobial and antifungal, wherein the coating does not cause damage to the environment nor to human health. The Prosopis juliflora water-soluble leaf ethanolic extract has beneficial effects in reducing the ripening-related symptoms and increases the storage shelf-life of post-harvest vegetation in various temperature conditions for a long period of time (e.g., greater than 5 days, greater than 10 days, or greater than 20 days).

The Prosopis juliflora water-soluble leaf ethanolic extract is water soluble and stable over time (e.g., at least 24 hours, at least 48 hours, or more) and heat up to 70° C. Therefore, the Prosopis juliflora water-soluble leaf ethanolic extract can be applied in the form of a spray or embedded in any stabilizing packaging. For example, a method of protecting post-harvest vegetation can include applying Prosopis juliflora water-soluble leaf ethanolic extract includes dissolving the composition in water to form a composition solution, and spraying the composition solution onto the post-harvest vegetation.

In an embodiment, the disclosure provides a composition comprising the Prosopis juliflora water-soluble leaf ethanolic extract. The composition can be prepared by the methods disclosed herein.

### EXAMPLES

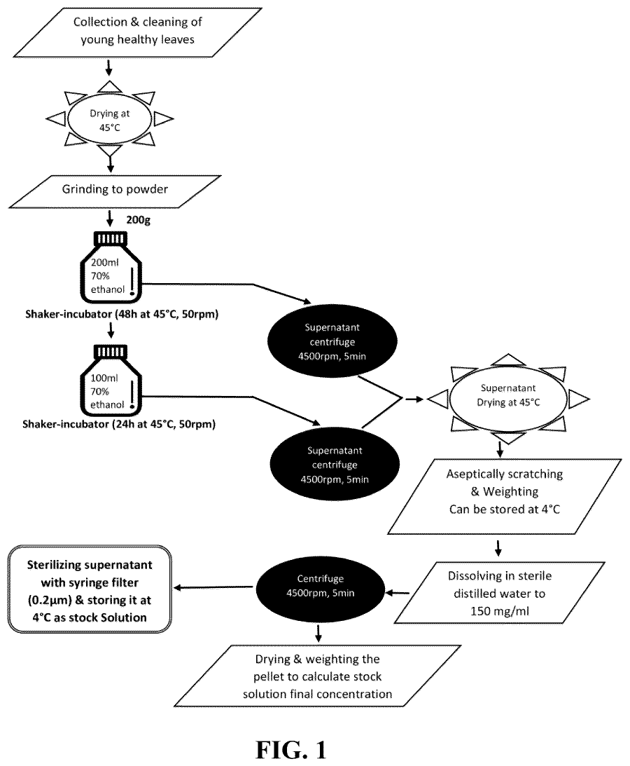

To prepare the extract, 200 mL of 70% ethanol was mixed with twenty grams of leaf powder in a bottle. The mixture was then incubated at 45° C. with shaking (50 cycles/min) for 48 hours. Supernatants were filled in 50 mL tubes and centrifuged at 4500 rpm for 2 to 5 min depending on the solution turbidity. Pellets were avoided and supernatants were filtered using Whatman filter papers and poured into 150 mm glass Petri-plates and transferred to a pre-sterilized oven at 45° C. to evaporate the solvent. The dried (powdery or gummy) material was aseptically scratched from the surface of the petri-plates using a sterile scalpel. The bottle was re-filled with 100 mL of 70% ethanol and incubated at 45° C. with shaking (50 cycles/min) for 24 hours. The second elution was treated the same way: Supernatants were filled in 50 mL tubes and centrifuged at 4500 rpm for 2 to 5 min depending on the solution turbidity. Pellets were avoided and supernatants were filtered using Whatman filter papers and poured into 150 mm glass Petri-plates and transferred to a pre-sterilized oven at 45° C. to evaporate the solvent. The dried (powdery or gummy) material was aseptically scratched from the surface of the petri-plates using a sterile scalpel. Leaf ethanolic crude extract was resuspended in sterile distilled water to prepare stock solutions with a concentration of 150 mg/mL. Tubes were then centrifuged and the water-soluble supernatant was taken and stored at 4° C. to be used in the analysis, while the non-water soluble pellet was incubated at 45° C. to dry, the pellet was then weighed and the new concentration of the solution was re-calculated. It was noticed that the mass of the pellet was around 9.5% of the initial total mass of the ethanolic extract, making the final concentration of the stock solution around 125 mg/mL. The suspension was sterilized using a syringe filter 0.2 μm. FIG. 1 summarizes the ethanolic extraction method.

### Example 1—Effectiveness of PJ-WS-LE Extract of the Six Strains of Penicillium Pour Plate Method

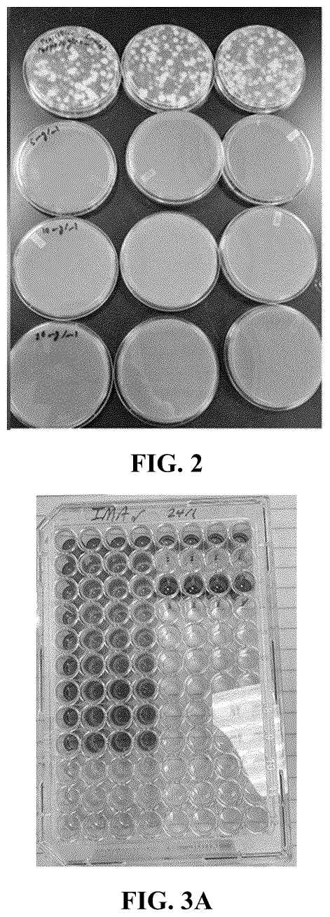

PJ-WS-LE extract showed 100% spore inhibition at the three evaluated concentrations (20, 10 and 5 mg/ml). Results of strain 1 are shown as sample results in FIG. 2.

### Example 2—Minimum Inhibitory Concentration (MIC) of PJ-WS-LE Extract on the Six Strains of Penicillium-96-Well Plate Method Results

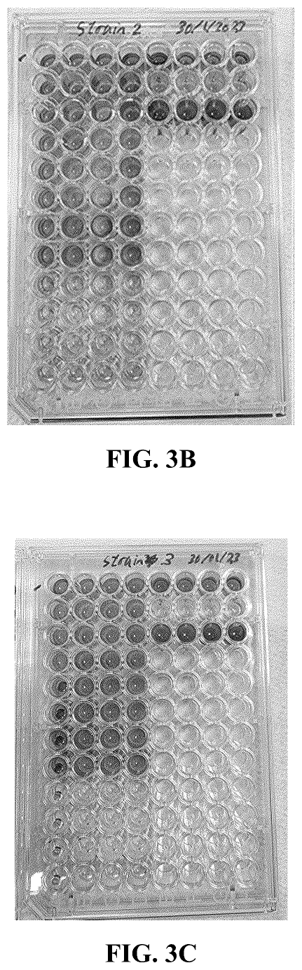

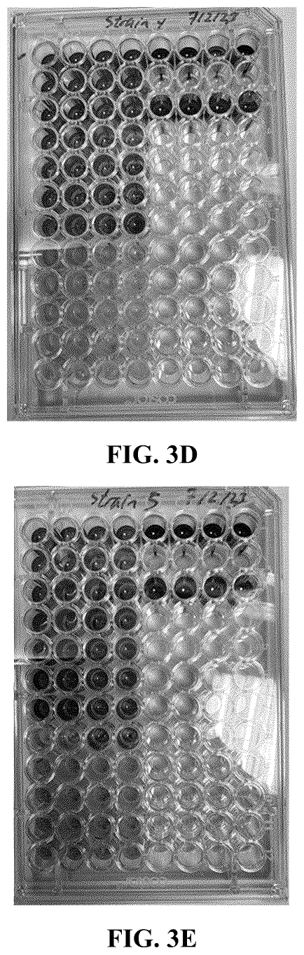

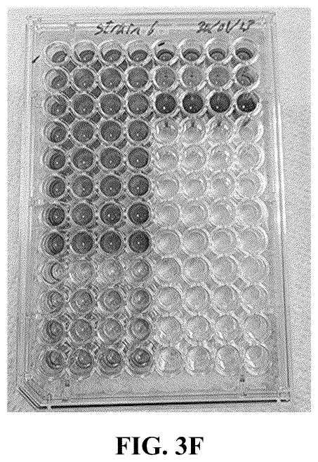

The 96-well plate results are shown in FIGS. 3A-3F. Results shows that the MIC of PJ-WS-LE extract to the six Penicillium strains is between 0.25 mg/ml and 1 mg/ml. Detailed MIC are shown in Table 1.

TABLE 1
MIC of the six Penicillium strains.

| Penicillium Strain number | MIC (mg/ml) |
|---|---|
| Strain 1 | 0.25 |
| Strain 2 | 0.5 |
| Strain 3 | 0.5 |
| Strain 4 | 1 |
| Strain 5 | 1 |
| Strain 6 | 0.5 |

### Example 3—Demonstration of the Spoiling Characteristic of the Isolated Fungi

Spore suspension of Penicillium strains 2-5 infected the wounded citrus fruits. It was expected that strain 1 (Penicillium purpurogenum) would not because strain 1 is not a known citrus fruits spoiling agent.

### Example 4—Determination of the Minimum Infectious Spores Concentration

An initial spores extract was prepared by mixing 2 disks (4 mm diameter) of 5-days old culture of Penicillium in 5 mL of sterile distilled water. The mixture was vortexed and the initial spores concentration of the suspension was determined with a heamatocytometer to be approximately 106 spores/mL. Then 1 to 10 serial dilutions of the initial suspension were prepared (10-1 to 10-6). The lowest spore concentration that caused infection in the fruit in all strains was 10-4 (an approximate spore concentration of 100 spores/mL). This was used for the rest of the experiments.

### Example 5—Determination of the Curative and Preventive Effect of PJ-WS-LE Extract on Artificially Inoculated Lemons and Oranges

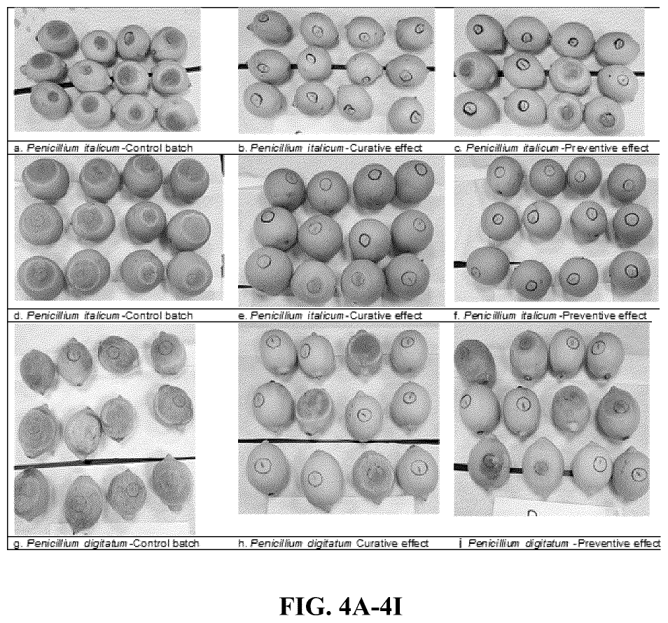

For this experiment, one strain of Penicillium digitatum and one strain of Penicillium italicum were used. The results after 10 days are shown in FIG. 4 (Penicillium digitatum with oranges where the fungal growth was too high to allow removal from the sterile bags are not shown).

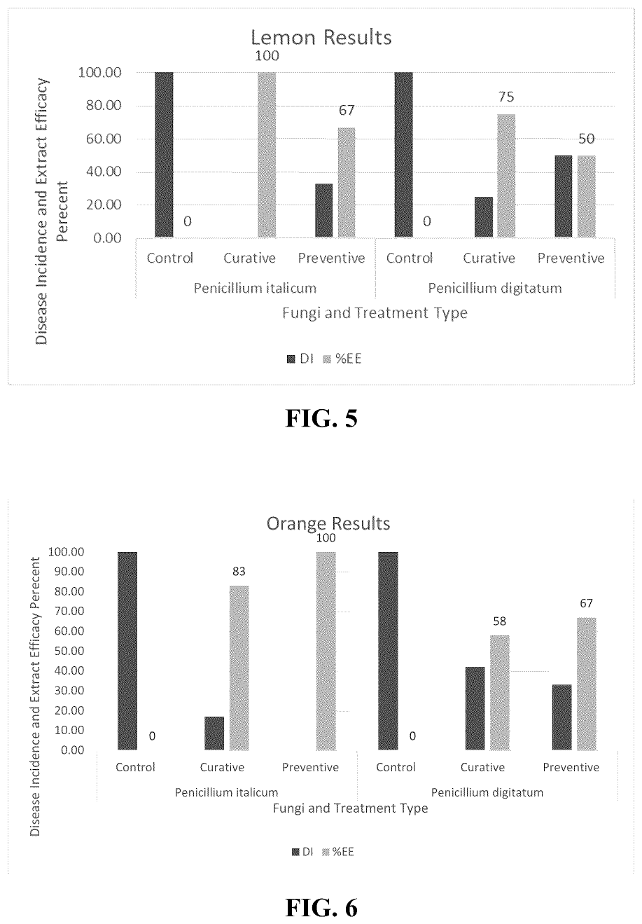

The efficacy of PJ-WS-LE extract was more obvious on Penicillium italicum with a 100% curative efficacy on lemons and 100% preventive efficacy on oranges (FIG. 5). Samples showing Penicillium italicum upon PJ-WS-LE extract treatment showed slight growth as it can be seen in FIG. 4c and FIG. 4e. This indicates that an extra application of the extract would have been enough to irradiate the infection and protect the fruits.

Penicillium digitatum extract efficacy was 75% in the lemons. Similarly, more than two third of the orange samples were protected from the induced infection in the preventive treatment (FIG. 6). This indicates that if formulated in a stabilizer, used at a higher concentration, or more often, the extract would potentially prevent Penicillium digitatum infection in citrus fruits.

The examples are embodiments for implementing the invention and are not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method of preparing a Prosopis juliflora water-soluble leaf ethanolic extract, the method comprising:
providing Prosopis juliflora leaf powder;
combining the Prosopis juliflora leaf powder and a first solvent comprising a first ethanol solution in a first shaker-incubator for at least 24 hours to obtain a first shaken solution;
isolating a first supernatant from the first shaken solution;
obtaining a first dried material from a centrifugation of the first supernatant and evaporation of the first solvent;
combining the Prosopis juliflora leaf powder and a second solvent comprising a second ethanol solution in a second shaker-incubator for at least 24 hours to obtain a second shaken solution;
isolating a second supernatant from the second shaken solution; and
obtaining a second dried material from a centrifugation of the second supernatant and evaporation of the second solvent;
adding the first dried material and the second dried material to distilled water to prepare a stock solution; and
obtaining a third supernatant from centrifugation of the stock solution to form the Prosopis juliflora water-soluble leaf ethanolic extract.

2. The method of claim 1, wherein the stock solution has a concentration of 100 mg/mL to 200 mg/mL.

3. The method of claim 1, wherein the ethanol solution is 70% ethanol.

4. The method of claim 1, wherein the first supernatant and the second supernatant are isolated via filtration.

5. The method of claim 1, wherein the third supernatant is stored at 3° C. to 6° C.

6. The method of claim 1, wherein the Prosopis juliflora leaf powder and the first ethanol solution in the first shaker-incubator is at a temperature of about 45° C., and shaking about 50 cycles/min for at least 48 hours.

7. The method of claim 1, wherein the first dried material and a second ethanol solution in a second shaker-incubator in the second shaker-incubator is at a temperature of about 45° C., and shaking about 50 cycles/min for at least 24 hours.

8. The method of claim 1, wherein providing Prosopis juliflora leaf powder comprises drying Prosopis juliflora leaves at a temperature of 40° C. to 50° C., and grinding the dried Prosopis juliflora leaves into the Prosopis juliflora leaf powder.

9. The method of claim 1, further comprising sterilizing the third supernatant via a syringe filter and storing at a temperature of 3° C. to 5° C.

10. A composition comprising the Prosopis juliflora water-soluble leaf ethanolic extract of claim 1.

11. A method of protecting post-harvest vegetation, the method comprising applying the composition of claim 10 to the outer surface of post-harvest vegetation.

12. The method of claim 11, wherein applying the composition includes dissolving the composition in water to form a composition solution, and spraying the composition solution onto the post-harvest vegetation.
